(19) United States
(12) Patent Application Publication
(10) Pub. No.: US 2007/0299772 A1
(43) Pub. Date: Dec. 27, 2007

(54) APPARATUS, SYSTEM, AND METHOD FOR AN ELECTRONIC RECEIPT SERVICE FOR CONSUMERS, MERCHANTS AND FINANCIAL INSTITUTIONS

(76) Inventors: Scott David Mastie, Longmont, CO (US); Joan LaVerne Mitchell, Longmont, CO (US)

Correspondence Address: Kunzler & McKenzie, 8 EAST BROADWAY, SUITE 600, SALT LAKE CITY, UT, 84111, US

(21) Appl. No.: 11/422,557

(22) Filed: Jun. 6, 2006

(51) Int. Cl. G06Q 40/00

(52) U.S. Cl. 705/39; 705/44

(57) ABSTRACT

An apparatus, system, and method are disclosed for managing transactional data for consumers, employers, merchants, and financial institutions. A profile module is included to receive a profile created from client input. The profile comprises user client information, transactional information chosen by the client to be gathered from the client's transactions, and client preferences. The client is any of a consumer, a merchant, an employer, and a financial institution. A transaction gathering module is included to receive transactional information of a transaction from a point of sale. A transaction storage module is included to store the received transactional information in a database. A comparison module is included to compare the received transactional information with a client profile and to identify information from the received transactional information matching the client profile. A reporting module is included to report the identified information from the received transactional information to the client.

### BACKGROUND OF THE INVENTION

1. Field of the Invention

This invention relates to electronic transaction management and more particularly relates to a service provided to consumers, merchants, employers, and financial institutions to manage and supply information related to transactions.

2. Description of the Related Art

Computers have become an integral part of financial and other transactions. Before computers, merchants and banks had to deal with mountains of paper to track transactions between a consumer and a merchant and then the merchant had to deal with a financial institution such as a bank, credit card company, or the like at a later time to post a credit card charge, get payment for a check, deposit cash, etc. Employers relied on paper receipts and forms filled out by employees to track expenses. Financial institutions had to deal with a time lag of days or weeks between when a consumer purchased something and when the financial institution could verify funds or credit worthiness. Consumers had to manage finances by trying to remember to write down expenditures, by balancing checking accounts with pencil and paper, and other cumbersome procedures.

Computers have somewhat simplified transactions. Merchants may have computer programs to track inventory, store transactional data, manage credit card and checking transactions, etc. With computers, financial institutions can store vast amounts of data on computers, participate in e-commerce, shorten the time required to verify funds, etc. Employers can use financial programs to track employee expenses. Consumers can access accounts online, use financial planning software to help with budgets, download banking and credit card transactions, maintain tax records, etc.

With all of the advances in computers, however, consumers, employers, merchants, and financial institutions still must spend a lot of time doing many of the same tasks, only in a slightly different way. Merchants must still deal with checks differently than credit card transactions and sophisticated merchants can connect inventory management with cash register sales. Employers must still rely on expense reports generated by employees which may be inaccurate. Consumers must still spend plenty of time managing numerous credit card accounts, bank accounts, charge accounts, etc. and must access the accounts separately. Only the computer savvy consumer attempts to automate all or even a portion of the consumer's accounts by using a financial planning program. Consumers must still have a paper receipt for most returns or exchanges, and this can be problematic if original paper receipts are lost or damaged. Consumers and employees still have a difficult time keeping and categorizing receipts required for employee expense reports and for tax returns.

A major hurdle to simplification of transactions is that so many different entities get involved with transactions. Financial institutions have come a long way in simplifying transactions, but each financial institution only tracks its own customers. Customers must still manage each account separately, when doing business with more than one financial institution or merchant. Each checking account or credit card account from a unique financial institution must be tracked individually by the consumer. Cash transactions require a manual tracking method such as keeping receipts and entering the transactions into a computer individually.

From the foregoing discussion, it should be apparent that a need exists for an apparatus, system, and method that provide a unified method for managing transactional data for consumers, employers, merchants, and financial institutions. Beneficially, such an apparatus, system, and method would allow clients that are consumers, employers, merchants, and financial institutions to track transactional data of all kinds and to control their own client profile. The client profile would be used to compare with point of sale information to generate reports, alarms, notifications, etc.

### SUMMARY OF THE INVENTION

The present invention has been developed in response to the present state of the art, and in particular, in response to the problems and needs in the art that have not yet been fully solved by currently available methods for managing transactional data. Accordingly, the present invention has been developed to provide an apparatus, system, and method for managing transactional data for consumers, employers, merchants, and financial institutions that overcome many or all of the above-discussed shortcomings in the art.

The apparatus to manage transactional data for consumers, employers, merchants, and financial institutions is provided with a plurality of modules configured to functionally execute the necessary steps of creating a profile for a client, receiving transactional data, comparing the transactional data with the profile, and reporting the identified transactional data. These modules in the described embodiments include a profile module that receives a profile created from client input. The profile comprises user client information, transactional information chosen by the client to be gathered from the client's transactions, and client preferences. The client is any of a consumer, a merchant, an employer, and a financial institution. A transaction gathering module is included to receive transactional information of a transaction from a point of sale. A transaction storage module is included to store the received transactional information in a database. A comparison module is included to compare the received transactional information with a client profile and to identify information from the received transactional information matching the client profile. A reporting module configured to report the identified information from the received transactional information to the client.

In one embodiment, the transaction comprises a cash transaction, a check transaction, a debit transaction, a bartered transaction, and a credit transaction. The apparatus, in one embodiment, is configured to include a transaction validation module that validates the transaction before committing to the transaction. In another embodiment, the apparatus includes a transaction authorization module that transmits transactional information from the point of sale to a transaction validation service of a client financial institution related to the transaction and returns authorization or rejection of the transaction to the point of sale before completion of the transaction. In another embodiment, the transaction comprises a scanned image of a check.

The apparatus is further configured, in one embodiment, to include an association module that associates a transaction with a product sold during the transaction. In a further embodiment, the apparatus may be configured to include an assignment module that tracks assignment of the product from a first consumer to a second consumer to allow the second consumer to return the product. In another embodiment, the association module further comprises electronically associating the transaction with the product and the assignment module further comprises tracking assignment of the product through notification by the first consumer of the assignment.

In one embodiment, the transactional information further comprises biometric data collected from the consumer at the point of sale. In a further embodiment, the biometric data is selected from the group consisting of a photograph, a fingerprint, a signature, and a video of the transaction. In another embodiment, the apparatus includes an alert module configured to transmit an alert to a client in response to the transaction triggering a pre-defined alert from the client's profile. In yet another embodiment, the apparatus includes a statistics module that generates requested statistics based on transactional information.

Another apparatus of the present invention is also presented to manage transactional data. The apparatus includes a transaction transmitting module that transmits transactional information from a point of sale to a server. The apparatus also includes a transaction approval module that receives authorization or rejection of the transaction from the server prior to completion of the transaction. The server is configured to include a profile module that receives a profile from a client. The profile comprises user client information, transactional information chosen by the client to be gathered from the client's transactions, and client preferences. The client is any of a consumer, a merchant, an employer, and a financial institution. The server includes a transaction storage module that stores the received transactional information in a database. The server includes a comparison module that compares the received transactional information with a client profile and identifies information from the received transactional information matching the client profile. The server includes a transaction authorization module that returns authorization or rejection of the transaction for check, debit, and credit transactions to the apparatus at the point of sale. Authorization or rejection of the transaction comprises any of verifying availability of funds from a financial institution related to the transaction type and comparison of biometric data of the client's profile with transactional information. The server includes a reporting module that reports the identified information from the received transactional information to the client.

A system of the present invention is also presented to manage transactional data for consumers, merchants, and financial institutions. The system may be embodied by a computer network, at least one client computer in communication with the computer network, a data storage device, and a server in communication with the data storage device and the at least one client computer over the computer network. In particular, the system, in one embodiment, includes a profile module that receives or creates a profile from a client. The profile comprises user client information, transactional information chosen by the client to be gathered from the client's transactions, and client preferences. The client is any of a consumer, a merchant, and a financial institution.

The system includes a transaction gathering module that receives transactional information at the server from a point of sale at a client computer. The transactional information comprises transaction type, transaction amount, timestamp information, consumer information, financial institution information where applicable, and merchant information. The system includes a transaction storage module that stores the received transactional information in a database on the data storage device. The system includes a comparison module that compares the received transactional information with a client profile and identifies information from the received transactional information matching the client profile. The system includes a reporting module that reports the identified information from the received transactional information to the client at the client computer. In one embodiment, the client controls information stored in the profile. In another embodiment, the data storage device is remote from at least one client computer.

A method of the present invention is also presented for managing transactional data for consumers, employers, merchants, and financial institutions. The method in the disclosed embodiments substantially includes the steps necessary to carry out the functions presented above with respect to the operation of the described apparatus and system. In one embodiment, the method includes receiving a profile from a client. The profile comprises user client information, transactional information chosen by the client to be gathered from the client's transactions, and client preferences. The client is any of a consumer, a merchant, an employer, and a financial institution. The method includes receiving transactional information of a transaction from a point of sale. The transactional information includes transaction type, transaction details, timestamp information, consumer information, financial institution information where applicable, and merchant information. The method includes storing the received transactional information in a database and comparing the received transactional information with a client profile and identifying information from the received transactional information matching the client profile. The method includes reporting the identified information from the received transactional information to the client.

In one embodiment, the transactional information comprises transaction type, transaction amount, timestamp information, consumer information, financial institution information where applicable, and merchant information. In a further embodiment, the method includes receiving from the point of sale transactional information and returning authorization or rejection of the transaction based on available funds to the merchant at the point of sale before completion of the transaction. In another embodiment, returning authorization or rejection of a transaction further includes comparing transactional information with biometric data of a consumer client profile.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a system to manage transactional data for consumers, employers, merchants, and financial institutions in accordance with the present invention;

FIG. 2 is a schematic block diagram illustrating one embodiment of an apparatus to manage transactional data for consumers, employers, merchants, and financial institutions in accordance with the present invention;

FIG. 3 is a schematic block diagram illustrating another embodiment of an apparatus to manage transactional data for consumers, employers, merchants, and financial institutions in accordance with the present invention;

FIG. 4 is a schematic flow chart diagram illustrating one embodiment of a method to manage transactional data for consumers, employers, merchants, and financial institutions in accordance with the present invention;

FIG. 5 is a schematic flow chart diagram illustrating one embodiment of a method to manage transactional data for consumers, employers, merchants, and financial institutions and to authorize transactions in accordance with the present invention;

FIG. 6 is a schematic flow chart diagram illustrating a more detailed embodiment of a method to manage transactional data for consumers, employers, merchants, and financial institutions in accordance with the present invention; and

FIG. 7 is a schematic flow chart diagram illustrating one embodiment of a method to manage returns for merchants in accordance with the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure, data base, etc. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a signal bearing medium may take any form capable of generating a signal, causing a signal to be generated, or causing execution of a program of machine-readable instructions on a digital processing apparatus. A signal bearing medium may be embodied by a transmission line, a compact disk, digital-video disk, a magnetic tape, a Bernoulli drive, a magnetic disk, a punch card, flash memory, integrated circuits, or other digital processing apparatus memory device.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams described herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

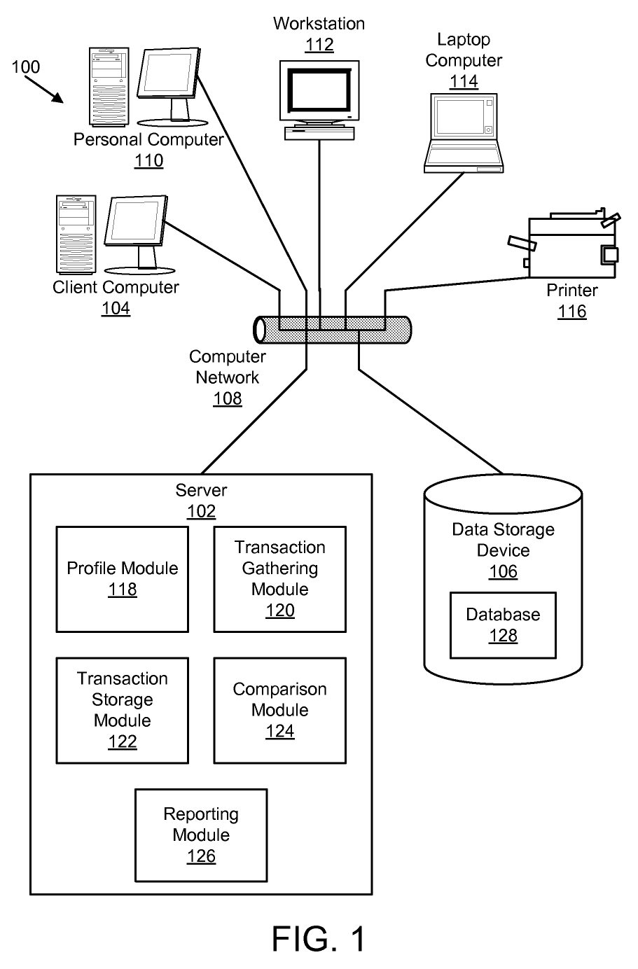

FIG. 1 is a schematic block diagram illustrating one embodiment of a system 100 to manage transactional data for consumers, employers, merchants, and financial institutions in accordance with the present invention. The system 100, in one embodiment, includes a server 102, at least one client computer 104, and a data storage device 106 connected by a computer network 108. The system 100 may also include computing equipment such as personal computers 110, workstations 112, laptop computers 114, and printers 116. In one embodiment, the server 102 includes a profile module 118, a transaction gathering module 120, a transaction storage module 122, a comparison module 124, and a reporting module 126. The data storage device 106, in one embodiment, includes a database 128. The components and modules of the system 100 are described below.

The server 102 may include one or more computers. The server 102 may comprise one or more mainframe computers, blade servers, standalone servers, workstations 112, personal computers 110, or the like. The server 102 may be linked to one or more data storage devices 106 or may include data storage devices 106. The server 102 may be linked to one or more data storage devices 106 over a computer network 108, which may comprise a local area network, a wide area network, a wireless network, a storage area network, and the like. The server 102 may comprise one computer or many computers in one or different locations. One of skill in the art will recognize other implementations of a server 102 to manage transactional data for consumers, employers, merchants, and financial institutions.

The client computer 104 may be a personal computer 110, a server 102, a workstation 112, a laptop computer 114, or any other computer or combination of computers capable of communicating with the server 102. The client computer 104 may also be a PDA, cell phone, kiosk, or any other device capable of providing internet access. The computer network 108 may comprise routers, switches, hubs, servers 102, cables, etc. and may include wireless communication, the Internet, a wide area network, a local area network, or any other means to connect the server 102 to the client computer 104, and to the data storage device 128. The computer network 108 may include an array of other connected devices such as personal computers 110, workstations 112, laptop computers 114, printers 116, and the like. One of skill in the art will recognize other configurations of a client computer 104 and a computer network 108 capable of supporting management of transactional data for consumers, employers, merchants, and financial institutions.

The data storage device 106 may include one or more hard disk drives, optical drives, removable media drives, tape storage, flash memory, etc. The data storage device 106 may include a redundant array of inexpensive disks (“RAID”) and may be in the server 102 or connected to the server 102 through a computer network 108 such as a storage area network, fiber channel network, wide area network, or the like. The data storage device 106 includes, in one embodiment, a database 128 capable of storing transactional data, client profiles, and the like. The database 128 may be in one location or may be distributed. One of skill in the art will recognize other forms of a database 128 capable of storing transactional data, user profiles, and the like.

The server 102, in one embodiment, includes a profile module 118 that receives a profile created from client input, the profile comprising user client information, transactional information chosen by the client to be gathered from the client's transactions, and client preferences. Client preferences may include preferences about how information is reported to the client, type of information collected, where information is sent, etc. Transactional information or transactional data comprises information related in some way to a transaction of any type. Transactional information may include a purchase price, a product identifier, purchaser information, biometric data related to the purchaser, account information for a credit card, debit card, or checking account, cash serial numbers, and the like. The client may be a consumer, a merchant, an employer, a financial institution, a business, an organization, or other person or entity engaging in any type of transaction.

Typically, the profile module 118 allows clients to control input to a profile. A consumer client, through the profile module 118, may add personal information such as account numbers, names, phone numbers, addresses, transaction preferences, and the like. A consumer client may elect to have transaction data relating to the client's taxes collected, collated, and reported separately. A consumer client may have transaction data sorted and reported into categories matching the client's budget. A consumer client may also enter biometric data through the profile module 118. For example, a consumer client may enter a signature, a fingerprint or similar print, a photograph, a voice recording, a retinal scan, or any other biometric data that may be used to identify the consumer client, to prevent unauthorized transactions and to identify theft. One of skill in the art will recognize other ways a consumer client may use the profile module to create a profile based on the client's input.

A merchant client, through the profile module 118, may add credit accounts, consumer names, consumer data, consumer shopping habits, consumer contact information for advertising, inventory information, merchandise or service prices, accounting information, consumer credit information, consumer credit limits, and the like. A merchant client may enter transaction categories, tax collection information, financial institution information, etc. One of skill in the art will recognize other information useful to a merchant that a merchant client may enter through the profile module 118.

An employer client, through the profile module 118, may add employee names, employee status, employee expense accounts, employee spending limits, expense categories, employee credit information, etc. An employer client may specify tax accounting information or other accounting categories. One of skill in the art will recognize other information that an employer client may enter through the profile module 118 to allow tracking of employee expenditures or other transactional information.

A financial institution client, through the profile module 118, may add customer account information, subscriber merchant information, customer credit limits, customer account balances, credit approval criteria, and the like. A financial institution client may create different categories of customer accounts, generate categories for gathering tax information, check image storage preferences, etc. One of skill in the art will recognize other ways a financial institution client may use the profile module 118 to create a profile useful for allowing transactions, committing transactions, gathering transactional data, etc.

In another embodiment, all or a portion of a client profile may be entered by a person or entity other than the client. For example, a service provider may add information to a client profile of a consumer based on transactions with a merchant. In another embodiment, a client has ownership of a profile and others may only modify the profile based on approval of the client. In yet another embodiment, a client profile may be created by a client and a different profile regarding the client may be kept by another client. For example, a merchant client may maintain a client profile for a consumer, a bank client may maintain a profile for the consumer and the consumer client may maintain another profile. A client may also use the profile module 118 to maintain or update a profile. In another embodiment, the profile module 118 may allow automatic updating of a profile based on client preferences, service provider rules, etc. One of skill in the art will recognize other ways a client or others may use the profile module 118 to create, maintain, and update a client profile.

The server 102 includes a transaction gathering module 120 that receives transactional information of a transaction from a point of sale. The transaction gathering module 120 may gather transactional information in the form of amount paid, items purchased, taxes paid, type of payment, and other basic transactional information. In addition, the transaction gathering module 120 may gather transactional data in the form of customer identification information. Transactional information may be any data, purchaser information, transaction conditions, etc. that is useful to a client for in a transaction.

In one embodiment, the transaction gathering module 120 gathers a signature from the purchaser. The signature may be handwritten and then scanned, entered by way of an electronic signature pad, or the like. The transaction gathering module 120 may gather purchaser information by way of a card though reading a bar code, swiping the card though a card reader, using a proximity sensor, etc. The transactional gathering module 120 may gather transactional information by scanning a check or other relevant document.

The transaction gathering module 120, in addition to a signature, may gather other biometric data. For example, a purchaser may enter a fingerprint or handprint using a fingerprint or handprint reader. In another example, a surveillance camera may take a photograph or video of a party to a transaction. A voice recorder may record a party's voice. A retinal scanner may be used to scan a party's retina. Biometric data may be used to deny approval of a transaction where the collected biometric data does not match biometric data previously collected by the profile module 118. One of skill in the art will recognize other ways for the transaction gathering module 120 to gather biometric data relevant to a transaction at a point of sale.

The transaction gathering module 120 may gather transactional data through a keyboard. A purchase or other event generating a transaction may create a point of sale at a merchant's store, at a computer terminal, or at with some other computing device. For example, a point of sale may be at the home, office, or other location of a purchaser, such as for an online sale or sale between parties where one party has a laptop computer, personal digital assistant (“PDA”), or other computing device.

The transactional gathering module 120 may also gather transactional information for any type of transaction. For example, the transactional gathering module 120 may gather transactional information for checking, debit, credit, cash, and bartered transactions. For checking, debit, and credit transactions, the transactional gathering module 120 may gather transactional information from the check, debit card, or credit card. For cash or bartered transactions, the transaction gathering module 120 may gather transactional information through a keyboard, through an identification card supplied by a purchaser, etc. One of skill in the art will recognize other ways that the transaction gathering module 120 may gather transactional information useful to a client.

The server 102 includes a transaction storage module 122 that stores the received transactional information in a database 128. The database 128 may comprise tables, fields, records, linked files, etc. The database 128 may be any data structure capable of storing transactional information in an accessible form. The transaction storage module 122 may store transactional data in a temporary location initially and then in a more permanent location at a later time. The transaction storage module 122 may receive transactional information from a point of sale at a merchant or may receive transactional information from many sources such as from a purchaser's computer and a merchant's computer, which may be the case in an online transaction. One of skill in the art will recognize other ways for the transaction storage module 122 to store transactional information in a form and location for access by clients and for use by the modules of the present invention.

The server 102 includes a comparison module 124 that compares the received transactional information with a client profile and identifies information from the received transactional information matching the client profile. In one embodiment, the comparison module 124 compares received transactional information with a consumer client profile. If the transactional information matches some aspect of the consumer client's profile, the comparison module 124 identifies transactional information from the received transactional information. For example, if the transactional data matches budget criteria from the client's profile, the comparison module 124 identifies the transactional data as matching the budget criteria. The transaction may be for the purchase of food so that the comparison module identifies the transactional information as matching the food category in a client's profile. A transaction for office equipment may be compared to the client's profile and identified by the comparison module 124 as matching a work expense budget category or a tax event category.

In another embodiment, the comparison module 124 compares received transactional data to a merchant client's profile and identifies information as matching the merchant client's profile. For example, a merchant's profile may categorize transactions by merchandise categories to target customers for advertising. The comparison module 124 may identify received transactional information for a purchase of baby formula as matching a merchant's profile category of baby products for targeted advertising. The comparison module 124 may also compare received transactional data to the merchant's profile regarding customers. The comparison module 124 may identify a customer's identity from the received transactional information and then match the customer to the merchant's profile for customers with a troubled credit history.

In another embodiment, the comparison module 124 may compare the received transactional information to that of an employer client's profile. The comparison module 124 may identify information from the transactional data for a car rental and may match the car rental information to the employer client's profile category of travel expenses. The comparison module 124 may identify information from an office product purchase and match the office product purchase to the employer client's profile category of office expenses.

In yet another embodiment, the comparison module 124 may compare the received transactional information to that of a financial institution client's profile. The comparison module 124 may identify account information from the transactional information and may identify that the account matches the financial institution's profile for accounts. For example, the comparison module 124 may compare an account number from transactional information and may identify that the account number is from a credit card company or from a particular bank. In another example, the comparison module 124 may compare transactional information regarding purchase price along with account number information of the purchaser to the applicable financial institution's profile or the purchaser's account status for transaction approval purposes. One of skill in the art will recognize other ways for the comparison module 124 to compare received transactional information to a client profile and to identify information from the transactional information that matches the client profile.

The server 102 includes a reporting module 126 that reports the identified information from the received transactional information to the client. The reporting module 126 may send identified information regarding individual transactions, raw identified information by category, identified information in a report format, periodic summaries, cash flow analysis, and the like. For example, the reporting module 126 may send a tax report to a client or to a client's accountant to assist in tax preparation. The reporting module 126, in another example, may transmit identified employee expense information to an employer client once a month in a report format or in a raw data format for the employer or employee to create an expense report. The reporting module 126 may report identified information separated into merchandise categories to a merchant client. The reporting module 126 may send identified information to a financial institution for each transaction. One of skill in the art will recognize other ways for the reporting module 126 to report identified information to the client.

While prior art methods of collecting and using transactional information provided bits and pieces of the invention described in the system 100, the system 100 provides a unified approach to collecting a client profile, gathering transactional information, comparing the profile and transactional information, identifying information that matches the profile, and reporting the identified information to a client. The client, in the system 100, may be a consumer, a merchant, an employer, a financial institution, a business, and the like. The system 100 allows tracking of a multitude of transaction types rather than just checking, debit, and credit transactions, which may be currently tracked in a limited way.

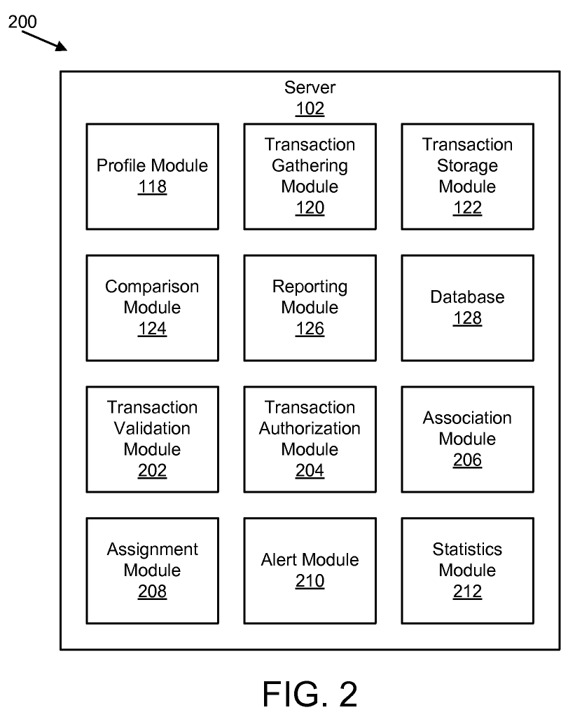

FIG. 2 is a schematic block diagram illustrating one embodiment of an apparatus 200 to manage transactional data for consumers, employers, merchants, and financial institutions in accordance with the present invention. The apparatus 200 includes a server 102 substantially similar to the server 102 described in relation to FIG. 1. The server 102 includes a profile module 118, a transaction gathering module 120, a transaction storage module 122, a comparison module 124, a reporting module 126, and a database 128 substantially similar to those described in relation to FIG. 1. The server 102 also includes a transaction validation module 202, a transaction authorization module 204, an association module 206, an assignment module 208, an alert module 210, and a statistics module 212, which are described below.

The apparatus 200 includes a database 128 shown in the server 102. The database 128 is capable of storing transactional data, client profiles, and the like and may be in a data storage device 106 within the server 102 or exterior to the sever 102. The database 128 is accessible to the server 102 through bussing or other means if the data storage device 106 is internal to the server 102 or through some type of computer network 108 if the data storage device 106 is external to the server 102.

The server 102 includes, in one embodiment, a transaction validation module 202 that validates the transaction before committing to the transaction. The transaction validation module 202 may use a two-phase commit protocol, or a similar procedure to ensure that a transaction involving more than one resource validates the transaction before committing the transaction. For example, a transaction might involve crediting one account and debiting another account. The transaction validation module 202 validates the transaction by determining that the resource crediting an account and the resource debiting an account have properly received and processed the accounts. The transaction validation module 202 then commits the transaction by issuing a commit call to the resources involved. The resources then commit the processing of both debiting and crediting the accounts by making the processing final, releasing any locks on the accounts, etc.

The transaction validation module 202, in another embodiment, may validate a transaction involving one resource before committing the transaction. The transaction may be a local transaction. The transaction validation module 202 may validate such a transaction by sending the transaction to the resource and then committing the transaction after receipt of an acknowledgement that the transaction was received or receipt of a confirmation that the transaction was processed. One of skill in the art will recognize other ways for the transaction validation module 202 to validate a transaction before committing the transaction.

The server 102 includes, in another embodiment, a transaction authorization module 204 that transmits transactional information related to a transaction type from the point of sale to a transaction validation service of a client financial institution related to the transaction and returns authorization or rejection of the transaction to the point of sale before completion of the transaction. For example, if the transaction involves a credit card of a credit card company, the transaction authorization module 204 may transmit transactional information regarding the credit card transaction, such as an account number, an account holder's name, an expiration date, a security code, a transaction amount, or the like. The transaction authorization module 204 may transmit the transactional data, in one embodiment, to a transaction validation service used by the credit card company for authorization. In another embodiment, the transaction authorization module 204 may transmit the transactional information to the credit card company for authorization. In yet another embodiment, the transaction authorization module 204 may transmit the transactional information to a service provider that manages the transactional data using the apparatus 200. The transaction authorization module 204 returns authorization or rejection of the transaction to the point of sale prior to completing the sale. In another embodiment, the transaction authorization module 204 returns a response that the transaction validation service, service provider, financial institution, etc. where the transaction was sent is unavailable. An unavailable response may be returned due to a communication failure or other problem resulting in an approval or rejection of the transaction not being returned. This advantageously allows an enhancement to traditional credit card authentication, via transmission of both the card information and biometric data, the combination of which is used by the financial institution to authenticate the user and the transaction, instead of solely basing the authentication on the card data as read at the point of sale.

In another embodiment, the transaction authorization module 204 transmits transactional information and returns authorization or rejection of the transaction for a checking transaction. In yet another embodiment, the transaction authorization module 204 transmits transactional information and returns authorization or rejection of the transaction for a debit transaction. The transaction authorization module 204 may also involve a cash transaction where the cash tendered is a large bill or is a suspected counterfeit and the authorization or rejection may involve confirmation that the serial number of the bill is valid or that the serial number is not involved in a counterfeiting scheme. In one embodiment, the transaction authorization module 204 rejects a transaction or notifies a cashier to reject a transaction if biometric data collected by the transaction gathering module 120 does not match biometric data stored with a client profile by the profile module 118.

Authorization or rejection may depend on account status, account balance, transaction amount, etc. Advantageously, the transaction authorization module 204 provides authorization or rejection of a transaction in real time for transactions other than just for credit or debit transactions and using more than just presented form of payment alone. The availability of authorization or rejection of a transaction, of course, depends on whether a financial institution or the like has signed up for such service, computer network 108 speed and availability, transactional validation service availability and response time, etc. One of skill in the art will recognize other ways that a transaction validation module 202 may transmit transactional information to a transactional validation service and return authorization or rejection of the transaction before completing the transaction.

The server 102 includes an association module 206 that associates a transaction with a product sold during the transaction. The product may be consumer goods, a service, a combination of consumer goods and services, and the like. The association module 206 may associate a transaction with a product through a unique identifier associated with the product. For example, a product may include a universal product code (“UPC”) bar code or other identifier to identify the manufacturer and product type. A product may also include a unique product identifier assigned to each item of a product type. In one embodiment, the association module 206 associates a transaction with the product type of the particular item sold during the transaction. In another embodiment, the association module 206 associates a transaction with the particular item sold through the unique product identifier. The unique product identifier may comprises a number included on the product, a serial number, a number encoded in a radio frequency identifier (“RFID”) chip in the product, etc.

In one embodiment, the association module 206 associates the transaction with the product by entering a transaction identifier and product type identifier or unique product identifier in the database 128. The transaction identifier may be generated by the association module 206, a merchant, a financial institution, etc. The association module 206, in another embodiment, may associate the product with the transaction while generating an electronic receipt. The association module 206 may associate transaction information, such as transaction details, biometric data, etc. collected by the transaction gathering module 120 with the transaction and purchased product. One of skill in the art will recognize other ways for the association module 206 to associate a transaction with a product sold during the transaction.

The server 102 may also include, in one embodiment, an assignment module 208 that tracks assignment of the product from a first consumer to a second consumer to allow the second consumer to return the product. The first consumer may assign the product through the assignment module 208 with or without the second consumer's knowledge. In another embodiment, the association module 206 electronically associates the transaction with the product and the assignment module 208 tracks assignment of the product through notification of by the first consumer of the assignment. Advantageously, the second consumer may return the product without a paper receipt. By creating an electronic receipt, the association module 206 allows a merchant to not issue a paper receipt. The assignment module 208 allows a first consumer to transfer all rights associated with the receipt to a second consumer. For example, when giving a gift, the assignment module advantageously allows all rights to be transferred to the gift recipient, including any product warranties and the right to return the product, in lieu of an accompanying paper receipt. The assignment may be valid for a product type or for a specific item, depending upon the type of association by the association module 206. One of skill in the art will recognize other ways that the assignment module 208 can transfer assignment from one consumer to another.

The server 102, in one embodiment, includes an alert module 210 that transmits an alert to a client in response to the transaction triggering a pre-defined alert of the client's profile. A pre-defined alert may be, for example, a purchase above an upper limit, an account balance dipping below a lower limit, an credit balance going above an upper limit, a transaction involving a certain vendor or product type, an employee purchasing a product, and the like. The alert may be transmitted in the form an email, phone call, a letter, a text message, an instant message, a video message, etc. One of skill in the art will recognize other alerts that may be defined in a client's profile and other ways a transaction may trigger an alert and ways that the alert module 210 may transmit an alert.

In another embodiment, the server 102 includes a statistics module 212 that generates requested statistics based on transactional information. A request may be made by a client, a system administrator, a government agency, and the like. In one embodiment, the statistics module 212 generates consumer purchase statistics and shopping habits for an economic governmental agency. Advantageously, this allows real-time economic forecasts to be created based on data as it becomes available, as opposed to waiting for quarterly summaries, and results as reported by individual retailers. In another embodiment, the statistics module 212 generates statistics regarding spending patterns and the like for a consumer client. In another embodiment, the statistics module 212 generates sales statistics for a merchant client. The statistics may involve past transactions, projected transactions, summaries by site, etc. The statistics module 212 may transmit the generated statistics in a report form or raw data and may deliver the report by generating a file, sending an email, producing a display on a monitor, printing the statistics, and the like. One of skill in the art will recognize other ways that the statistics module 212 may generate statistics from transactional data.

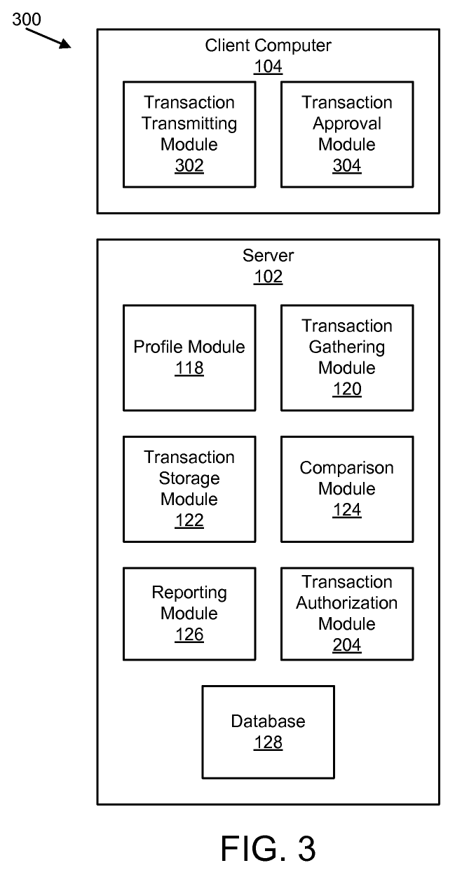

FIG. 3 is a schematic block diagram illustrating another embodiment of an apparatus 300 to manage transactional data for consumers, employers, merchants, and financial institutions in accordance with the present invention. The apparatus 300 includes a client computer 104 substantially similar to the client computer 104 described in relation to FIG. 1. The client computer 104 includes a transaction transmitting module 302 and a transaction approval module 304, which are described below. FIG. 3 includes a server 102 with a profile module 118, a transaction gathering module 120, a transaction storage module 122, a comparison module 124, a reporting module 126, database 128, and a transaction authorization module 204 shown for clarity and substantially similar to the server 102 and modules described in relation to FIGS. 1 and 2. It is understood, however, that the server 102 may also include other features and modules and may include the modules described in relation to FIG. 2.

The client computer 104 includes a transaction transmitting module 302 that transmits transactional information from a point of sale to the server 102. The transaction transmitting module 302 may transmit transactional information from a cash register, a scanner, a keypad, a card reader, a camera, a fingerprint reader, an electronic signature device, and the like. The transaction transmitting module 302 may be at any point of sale, including a merchant checkout counter, a consumer's computer, a PDA, a laptop computer 114, a personal computer 110, etc. The transaction transmitting module 302 may transmit transactional information regarding a transaction at one time or over multiple transmissions. The transaction transmitting module 302 may transmit transactional information through one or more computers or a computer system to the server 102 or may transmit the transactional information directly to the server 102. The data transmitted by the transaction transmitting module 302 may be encrypted, compressed, or both. One of skill in the art will recognize other ways that the transaction transmitting module 302 may transmit transactional information from a point of sale to the server 102

The server 102, in one embodiment, includes a profile module 118 that receives a profile from a client. The profile may include user client information, transactional information chosen by the client to be gathered from the client's transactions, and client preferences. The client may be any of a consumer, a merchant, an employer, a financial institution, and the like. The server 102 includes a transaction gathering module 120 that receives the transactional information from the point of sale. The server 102 includes a transaction storage module 122 that stores the received transactional information in the database 128. The server 102 includes a comparison module 124 that compares the received transactional information with a client profile and to identify information from the received transactional information matching the client profile. The server 102 may also include a reporting module 126 that reports the identified information from the received transactional information to the client.

The server 102 includes a transaction authorization module 204 that returns authorization or rejection of the transaction for check, debit, and credit transactions to the apparatus at the point of sale. Authorization or rejection of the transaction comprises verifying availability of funds from a financial institution related to the transaction type and comparison of biometric data of the client's profile with transactional information. In one embodiment the transaction authorization module 204 authorizes or rejects a transaction by verifying availability of funds. In another embodiment, the transaction authorization module 204 authorizes or rejects a transaction by comparing biometric data of the client's profile to with transactional information such as a signature, a fingerprint, a photograph, etc. In yet another embodiment, the transaction authorization module 204 authorizes or rejects a transaction by verifying funds and comparing biometric data. In yet another embodiment, a financial institution handles the biometric comparison on behalf of a client, and the transaction authorization module 204 authorizes or rejects a transaction via feedback from the financial institution.

The client computer 104 also includes a transaction approval module 304 that receives authorization or rejection of the transaction from the server prior to completion of the transaction. The approved transactions may include checking, debit, and credit transactions. The approved transactions may also include cash transactions where the authenticity of a bill tendered is in question. The transaction approval module 304 may receive an authorization or a rejection of a transaction, but may also receive information that transaction could not be authorized or rejected.

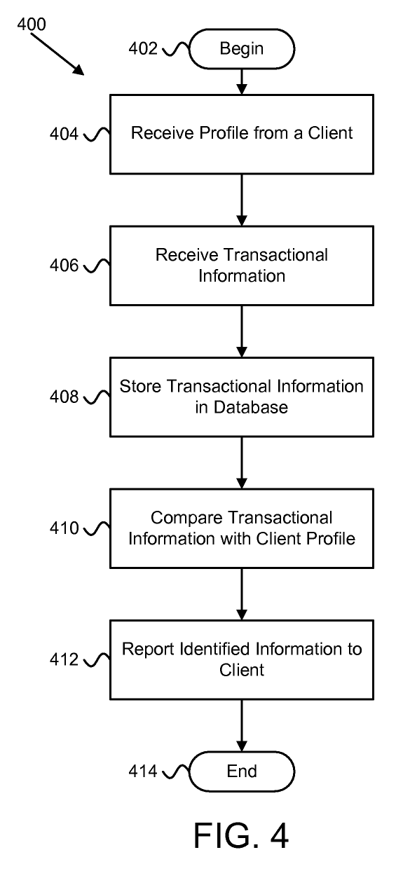

FIG. 4 is a schematic flow chart diagram illustrating one embodiment of a method 400 to manage transactional data for consumers, employers, merchants, and financial institutions in accordance with the present invention. The method 400 begins 402 and the profile module 118 receives 404 a profile created from client input. The transaction gathering module 120 receives 406 transactional information from a transaction transmitting module 302 at a point of sale. The transaction storage module 120 stores 408 the transactional information in the database 128. The database 128 may be located in the server 102 or accessible to the server 102. The comparison module 124 compares 410 the transactional information with the client profile and identifies information from the transactional information that matches the profile. The reporting module 126 reports 412 the identified information to the client and the method 400 ends 414.

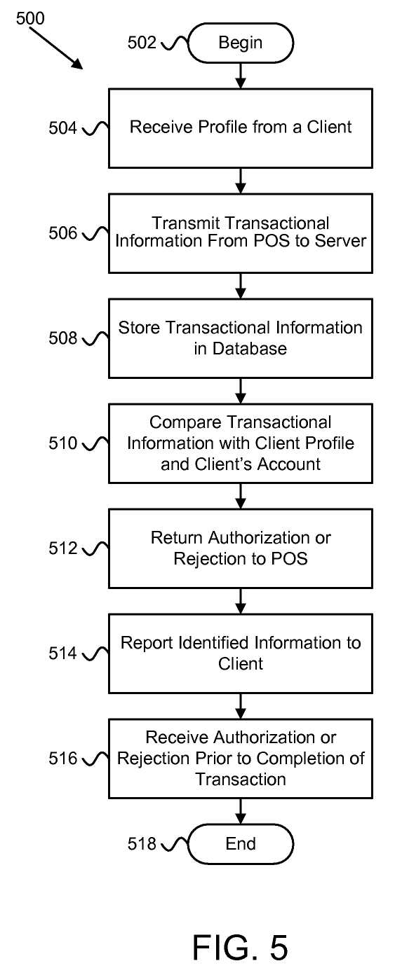

FIG. 5 is a schematic flow chart diagram illustrating one embodiment of a method 500 to manage transactional data for consumers, employers, merchants, and financial institutions and to authorize transactions in accordance with the present invention. The method 500 begins 502 and the profile module 118 receives 504 a profile created from client input. The transaction transmitting module 302 transmits 506 transactional information from a point of sale to the server 102. The transaction storage module 122 stores 508 the transactional information in the database 128. The comparison module 124 compares 510 the received transactional information with the applicable client profile. The comparison module 124 may compare 510 the transactional information with biometric data stored with the client profile. The biometric data may be used to determine if a party to the transaction, such as a customer purchasing goods, matches the client associated with the client profile.

The comparison module 124 also compares 510 the transactional information with an account balance to determine if there are sufficient funds to conduct the transaction, enough credit to allow the transaction, etc. The transaction authorization module 204, in one embodiment, returns 512 authorization or rejection of the transaction to the point of sale. In another embodiment, the transaction authorization module 204 returns 510 information that an authorization or rejection cannot be returned. The transaction authorization module 204 returns 512, in one embodiment, authorization based on an account having sufficient funds for the transaction. In another embodiment, the transaction authorization module 204 returns 512 authorization after verifying that the applicable credit account has enough remaining credit to cover the transaction. In yet another embodiment, the transaction authorization module 204 returns 512 authorization after the comparison module 124 determines that the biometric data collected at the point of sale matches biometric data in the applicable client profile. The transaction authorization module 204 may also return 512 a rejection. One of skill in the art will recognize other situations where the transaction authorization module 204 may return 512 an authorization, a rejection, or other information to the point of sale.

The reporting module 126 reports 514 the identified information to the client. The transaction approval module 304 receives 516 the authorization or rejection from the transaction authorization module 204 prior to completion of the transaction and the method 500 ends 518. Receiving approval prior to completion allows a cashier, authorized person, or computer program to authorize or reject the transaction at the point of sale.

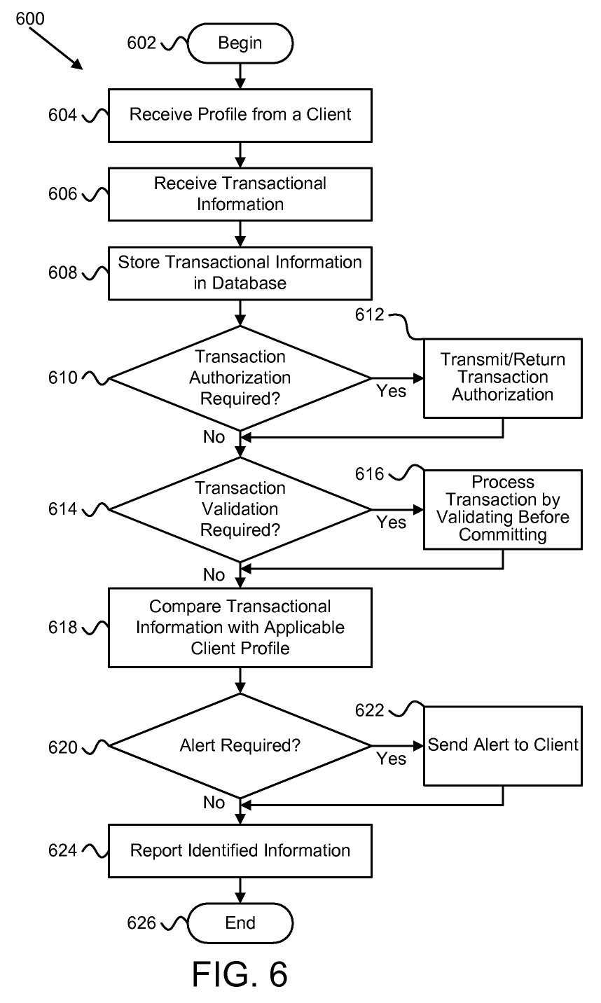

FIG. 6 is a schematic flow chart diagram illustrating a more detailed embodiment of a method 600 to manage transactional data for consumers, employers, merchants, and financial institutions in accordance with the present invention. The method 600 begins 602 and the profile module 118 receives 604 a profile created from client input. The transaction gathering module 120 receives 606 transactional information from a transaction transmitting module 302 at a point of sale. The transaction storage module 122 stores 608 the transactional information in the database 128.

The transaction authorization module 204 determines 610 if transaction authorization is required. If the transaction authorization module 204 determines 610 that transaction authorization is required, the transaction authorization module 204 transmits 612 transactional information related to a transaction type from the point of sale to a transaction validation service of a client financial institution related to the transaction. The transaction authorization module 204 returns 612 authorization or rejection of the transaction to the point of sale prior to completion of the transaction. The transaction validation module 202 determines 614 if a transaction validation is required. If the transaction validation module 202 determines 614 that a transaction validation is required, the transaction validation module 202 processes 616 the transaction by validating the transaction before committing the transaction.

The comparison module 124 compares 618 the received transactional information with the applicable client profile. The alert module 210 determines 620 if an alert is required. If the alert module 210 determines 620 that an alert is required, the alert module 210 sends 622 an alert to the client. In another embodiment, the alert module 210 determines 620 that an alert is required after the comparison module 124 determines that biometric data that is part of the transactional information does not match biometric data in the applicable client profile and the alert module 620 sends 622 an alert to police or to the appropriate merchant. The alert may include information to allow police to identify the location of the inappropriate transaction or instructions to a merchant, such as confiscating or destroying a credit card.

The reporting module 126 reports 624 identified transactional information to the client and the method 600 ends 626. The reporting module 126 may report 624 identified information at a time selected by the client, a pre-determined time, or just after a transaction. The reporting module 126 may send a report or raw data.

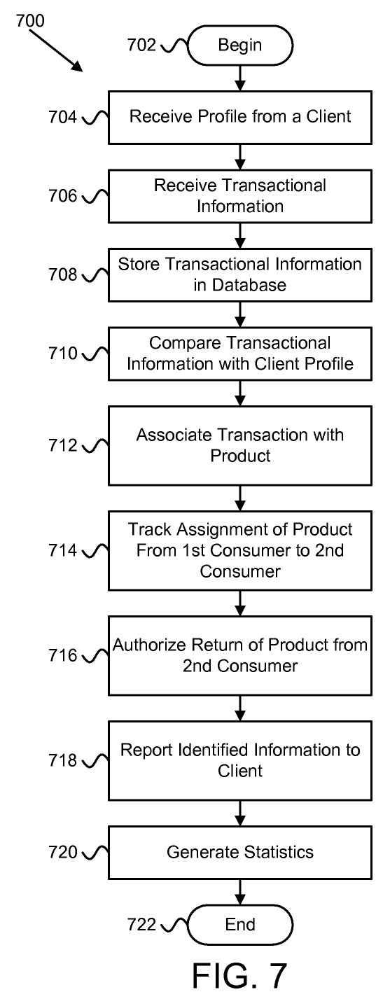

FIG. 7 is a schematic flow chart diagram illustrating one embodiment of a method 700 to manage returns for merchants in accordance with the present invention. The method 700 begins 702 and the profile module 118 receives 704 a profile created from client input. The transaction gathering module 120 receives 706 transactional information from a transaction transmitting module 302 at a point of sale. The transaction storage module 120 stores 708 the transactional information in the database 128. The comparison module 124 compares 710 the transactional information with the client profile and identifies information from the transactional information that matches the profile.

The association module 206 associates 712 the transaction with a product purchased by the client. The association module 206 may associate 712 the transaction with a product identifier or with an identifier unique to the specific item purchased, such as a computer serial number, or the RFID tag information of an item. The association may be tracked electronically. A paper receipt may or may not be issued to the client purchasing the product. The assignment module 208 tracks 714 an assignment of rights by a first consumer, the client that purchased the product, to a second consumer. The assignment module 208 may then authorize 716 return of the product to a merchant by the second consumer.

The reporting module 126 reports 718 identified transactional information to the client. In one embodiment, the statistics module 212 generates 720 statistics based on transactions for a client, governmental agency, or other entity and the method 700 ends 722. The statistics module 212 may generate 720 statistics by creating a file, sending an email, displaying the statistics, adding a record to a database 128, etc. Advantageously, the method 700 provides a convenient way for a client to assign rights of a purchased product to another person without having to give the other person a paper receipt. In addition, the method 700 provides a way to generate statistics regarding consumer purchases that transcends one particular transaction type.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus to manage transactional data for consumers, employers, merchants, and financial institutions, the apparatus comprising:
a profile module configured to receive a profile created from client input, the profile comprising user client information, transactional information chosen by the client to be gathered from the client's transactions, and client preferences, wherein the client is any of a consumer, a merchant, an employer, and a financial institution;
a transaction gathering module configured to receive transactional information of a transaction from a point of sale;
a transaction storage module configured to store the received transactional information in a database;
a comparison module configured to compare the received transactional information with a client profile and to identify information from the received transactional information matching the client profile; and
a reporting module configured to report the identified information from the received transactional information to the client.

2. The apparatus of claim 1, wherein the transaction comprises a cash transaction, a check transaction, a debit transaction, a bartered transaction, and a credit transaction.

3. The apparatus of claim 1, further comprising a transaction validation module configured to validate the transaction before committing to the transaction.

4. The apparatus of claim 1, further comprising a transaction authorization module configured to transmit transactional information related to a transaction type from the point of sale to a transaction validation service of a client financial institution related to the transaction and to return authorization or rejection of the transaction to the point of sale before completion of the transaction.

5. The apparatus of claim 4, wherein the transaction comprises a scanned image of a check.

6. The apparatus of claim 1, further comprising an association module configured to associate a transaction with a product sold during the transaction.

7. The apparatus of claim 6, further comprising an assignment module configured to track assignment of the product from a first consumer to a second consumer to allow the second consumer to return the product.

8. The apparatus of claim 7, wherein the association module further comprises electronically associating the transaction with the product and the assignment module further comprises tracking assignment of the product through notification by the first consumer of the assignment.

9. The apparatus of claim 1, wherein the transactional information further comprises biometric data collected from the consumer at the point of sale.

10. The apparatus of claim 9, wherein the biometric data is selected from the group consisting of a photograph, a fingerprint, a signature, and a video of the transaction.

11. The apparatus of claim 1, further comprising an alert module configured to transmit an alert to a client in response to the transaction triggering a pre-defined alert from the client's profile.

12. The apparatus of claim 1, further comprising a statistics module configured to generate requested statistics based on transactional information.

13. An apparatus to manage transactional data, the apparatus comprising:
a transaction transmitting module configured to transmit transactional information from a point of sale to a server, the server comprising
a profile module configured to receive a profile from a client, the profile comprising user client information, transactional information chosen by the client to be gathered from the client's transactions, and client preferences, wherein the client is any of a consumer, a merchant, an employer, and a financial institution;
a transaction storage module configured to store the received transactional information in a database;
a comparison module configured to compare the received transactional information with a client profile and to identify information from the received transactional information matching the client profile;
a transaction authorization module configured to return authorization or rejection of the transaction for check, debit, and credit transactions to the apparatus at the point of sale, wherein authorization or rejection of the transaction comprises any of verifying availability of funds from a financial institution related to the transaction type and comparison of biometric data of the client's profile with transactional information; and
a reporting module configured to report the identified information from the received transactional information to the client; and
a transaction approval module configured to receive authorization or rejection of the transaction from the server prior to completion of the transaction.

14. A system to manage transactional data for consumers, merchants, and financial institutions, the system comprising:
a computer network;
at least one client computer in communication with the computer network;
a data storage device; and
a server in communication with the data storage device and the at least one client computer over the computer network, the server comprising
a profile module configured to receive a profile from a client, the profile comprising user client information, transactional information chosen by the client to be gathered from the client's transactions, and client preferences, wherein the client is any of a consumer, a merchant, and a financial institution;
a transaction gathering module configured to receive transactional information at the server from a point of sale at a client computer, the transactional information comprising transaction type, transaction details, timestamp information, consumer information, financial institution information where applicable, and merchant information;
a transaction storage module configured to store the received transactional information in a database on the data storage device;
a comparison module configured to compare the received transactional information with a client profile and to identify information from the received transactional information matching the client profile; and
a reporting module configured to report the identified information from the received transactional information to the client at the client computer.

15. The system of claim 14, wherein the client controls information stored in the profile.

16. The system of claim 14, wherein the data storage device is remote from the at least one client computer.

17. A method for managing transactional data for consumers, employers, merchants, and financial institutions, the method comprising:
receiving a profile from a client, the profile comprising user client information, transactional information chosen by the client to be gathered from the client's transactions, and client preferences, wherein the client is any of a consumer, a merchant, an employer, and a financial institution;
receiving transactional information of a transaction from a point of sale, the transactional information comprising transaction type, transaction amount, timestamp information, consumer information, financial institution information where applicable, and merchant information;
storing the received transactional information in a database;
comparing the received transactional information with a client profile and identifying information from the received transactional information matching the client profile; and
reporting the identified information from the received transactional information to the client.

18. The method of claim 17, wherein the transactional information comprises transaction type, transaction amount, timestamp information, consumer information, financial institution information where applicable, and merchant information.

19. The method of claim 17, further comprising receiving from the point of sale transactional information and returning authorization or rejection of the transaction based on available funds to the merchant at the point of sale before completion of the transaction.

20. The method of claim 19, wherein returning authorization or rejection of a transaction further comprises comparing transactional information with biometric data of a consumer client profile.
